(19) United States
(12) Patent Application Publication
(10) Pub. No.: US 2025/0344267 A1
(43) Pub. Date: Nov. 6, 2025

(54) SYSTEM AND METHOD OF AUTOMATIC SWITCHING BETWEEN WIRELESS PERIPHERAL DEVICE TO INFORMATION HANDLING SYSTEM WIRELESS COMMUNICATION PROTOCOL LINKS BASED ON PRESENCE OF RF DONGLE

(71) Applicant: Dell Products LP, Round Rock, TX (US)

(72) Inventors: Harpreet S. Narula, Austin, TX (US); Manish Krishnaji Desai, Singapore (SG); Kai Leong Wong, Singapore (SG)

(73) Assignee: Dell Products LP, Round Rock, TX (US)

(21) Appl. No.: 18/652,985

(22) Filed: May 2, 2024

(51) Int. Cl. H04W 76/15; H04W 72/25; H04W 76/14

(52) U.S. Cl. CPC H04W 76/15; H04W 72/25; H04W 76/14

(57) ABSTRACT

A wireless peripheral device may comprise a wireless radio to operatively couple the wireless peripheral device to an information handling system, via a plurality of wireless communication channels in parallel, each supporting one of a plurality of wireless communication protocols previously assigned during a silent pairing process, the wireless radio to receive an over-the-air notification of presence of a dongle from the information handling system, and the hardware microcontroller to execute computer-readable program code instructions of an automatic wireless connection switching agent to automatically establish a wireless link with the information handling system via the dongle on a first of the plurality of wireless communication channels dedicated to transceiving data according to a first of the plurality of wireless communication protocols that is also supported by the dongle or to switch wireless communication channels at the wireless peripheral device when a dongle is not detected as present.

### FIELD OF THE DISCLOSURE

The present disclosure generally relates to wireless communication between a wireless peripheral device with an information handling system. The present disclosure more specifically relates to automatically switching between Bluetooth® and proprietary radio frequency (RF) wireless communication protocols for wireless links established between an information handling system and a wireless peripheral device based on the presence or absence of a proprietary RF dongle within communication range of the information handling system, as the user moves from one location to another with the wireless peripheral device and information handling system.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used to execute instructions of one or more workspace productivity applications, gaming applications, or the like. Further, the information handling system may include a radio to operatively couple a peripheral device to the information handling system.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system that may be operatively coupled to a wireless peripheral device that includes an automatic wireless connection switching module to establish wireless links with the wireless peripheral device, based on availability of various wireless communication protocols according to another embodiment of the present disclosure;

FIG. 2 is a graphic and block diagram illustrating an information handling system that may be operatively coupled to a wireless peripheral device, via a wireless link established with one of a plurality of wireless communication channels, based on availability of various wireless communication protocols according to another embodiment of the present disclosure;

FIG. 3 is a graphic and block diagram of a wireless peripheral device having a plurality of wireless communication channels through which an information handling system may be operatively coupled according to an embodiment of the present disclosure; and

FIG. 4 is a flowchart showing a method of automatically prioritizing wireless links established via a dongle for wireless communication, via over-the-air messaging between a wireless peripheral device and an information handling system according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Information handling systems may be operatively coupled to a peripheral device that allows the user to interact with the information handling system. These peripheral devices may include a mouse, a keyboard, a video display device, a stylus, a trackpad, and the like that allows a user to provide input to the information handling system and receive output from the information handling system. These peripheral devices may be wirelessly couplable to the information handling system through the use of various radio frequency (RF) radios in the information handling system and the peripheral device and/or a dongle that is operatively coupled to the information handling system via, for example, a universal serial bus (USB) port. This operative coupling includes an initial pairing of the wireless peripheral device to the information handling system, the exchange of pairing data between the wireless peripheral device and information handling system, and bonding or operatively coupling of the wireless peripheral device to the information handling system when authorized to do so.

Where dongles are used by the wireless peripheral device to communicate with the information handling system, a user may take the information handling system and wireless peripheral device away from the dongle and may be incapable of using the wireless peripheral device with the information handling system without that dongle. This may occur where the dongle is inserted into a USB port of a docking station operatively coupled to the information handling system and the user walks away from the docking station with the information handling system and wireless peripheral device (e.g., changes location of the workspace at least temporarily). In an example embodiment, various wireless protocols may be used with wireless peripheral devices. For example, when a dongle is used in some embodiments herein, a proprietary radiofrequency (RF) protocol may be used with proprietary modulation and proprietary wireless data communication features to provide additional or different performance.

The wireless peripheral device in embodiments herein may have been previously paired to an information handling system, via a plurality of different wireless connection protocols, such as the proprietary RF protocol described directly above, Bluetooth®, Bluetooth® Low Energy (BLE), or various types of Wi-Fi in multiple bands (e.g., 2.4 GHz, 5 GHz, 6 GHz, etc.). The systems and methods described herein provide for dongle radio frequency (RF) wireless connection and BT or BLE wireless connection with the same information handling system that, when the dongle is not present, automatically switches from the dongle RF wireless connection to the BT or BLE wireless connection when the dongle is no longer detected and available. In an embodiment, a priority mode may be defined so that if and when the dongle is discovered again, the wireless peripheral device again switches back from communicating with the information handling system via the BT or BLE wireless connection, or another available type of wireless communication protocol (e.g., Wi-Fi) to communicating with the information handling system via the dongle RF wireless connection. Thus, in an embodiment, a hardware processor for an information handling system executing code instructions of an automatic wireless connection switching module may work in tandem with a hardware microcontroller of the wireless peripheral device executing computer-readable program code of an automatic wireless connection switching agent to prioritize transceptions via the dongle by maintaining wireless transceptions with the information handling system via the dongle when the dongle is detected, and switch to a Bluetooth wireless communication, or other available or prioritized wireless communication protocol when the dongle is not detected.

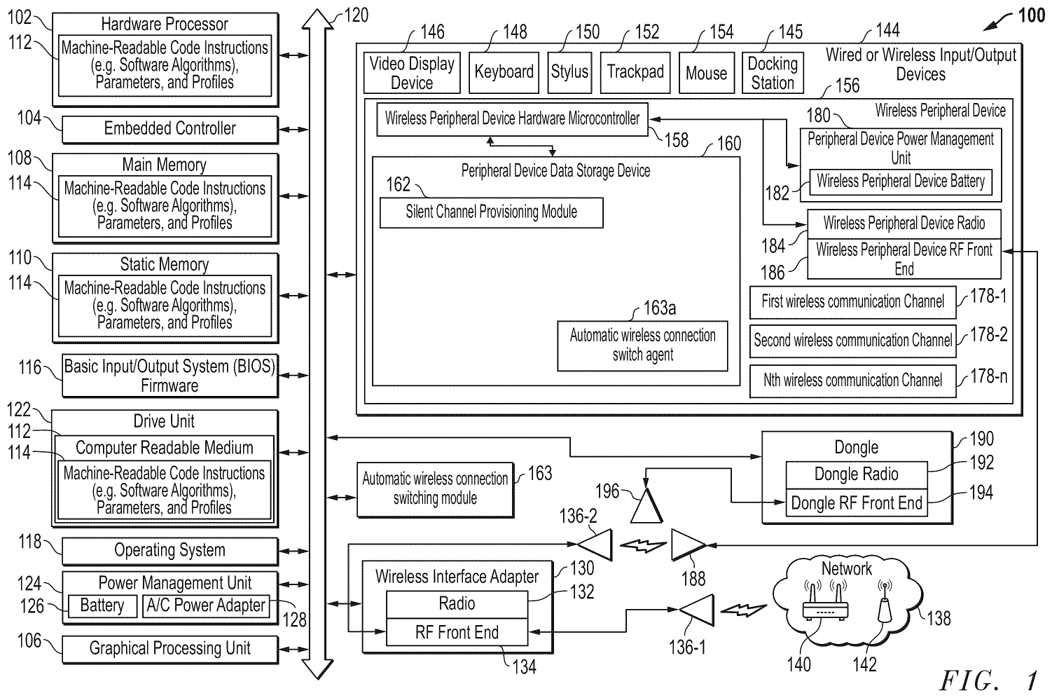

Turning now to the figures, FIG. 1 illustrates an information handling system 100 similar to the information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 140, a base station transceiver 142, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 108, (volatile (e.g., random-access memory, etc.), or static memory 110, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, or any combination thereof. Additional components of the information handling system 100 may include one or more storage devices such as static memory 110 or drive unit 122. The information handling system 100 may include or interface with one or more communications ports for communicating with external devices, as well as various input and output (I/O) devices 144, such as a mouse 154, a trackpad 152, a stylus 150, a keyboard 148, a video/graphics display device 146, docking station 145, the dongle 190 described herein, as well as the wireless peripheral device 156 described herein, or any combination thereof. Portions of an information handling system 100 may themselves be considered information handling systems 100.

Information handling system 100 may include devices or modules that embody one or more of the devices or execute instructions for one or more systems and modules. The information handling system 100 may execute instructions (e.g., software algorithms), parameters, and profiles 114 that may operate on servers or systems, remote data centers, or on-box in individual client information handling systems according to various embodiments herein. In some embodiments, it is understood any or all portions of instructions (e.g., software algorithms), parameters, and profiles 114 may operate on a plurality of information handling systems 100.

The information handling system 100 may include the hardware processor 102 such as a central processing unit (CPU) or other hardware processing resources. Any of the hardware processing resources may operate to execute code that is either firmware or software code. Moreover, the information handling system 100 may include memory such as main memory 108, static memory 110, and disk drive unit 122 (volatile (e.g., random-access memory, etc.), nonvolatile memory (read-only memory, flash memory etc.) or any combination thereof or other memory with computer readable medium 112 storing instructions (e.g., software algorithms), parameters, and profiles 114 executable by the hardware processor 102, EC 104, GPU 106, or any other hardware processing device. The information handling system 100 may also include one or more buses 120 operable to transmit communications between the various hardware components such as any combination of various I/O devices 144 as well as between hardware processors 102, an EC 104, the operating system (OS) 118, the basic input/output system (BIOS) 116, the wireless interface adapter 130, or a radio module, among other components described herein. In an embodiment, the hardware processor 102, EC 104, and/or GPU 106 may execute one or more bus drivers in order to transmit this data between the information handling system 100 and the input/output devices 144 described herein. In an embodiment, the information handling system 100 may be in wired or wireless communication with the I/O devices 144 such a keyboard 148, a mouse 154, video display device 146, stylus 150, trackpad 152, the wireless peripheral device 156 and dongle 190 described herein, among other peripheral devices.

As described herein, the information handling system 100 further includes a video/graphics display device 146. The video/graphics display device 146 in an embodiment may function as a liquid crystal display (LCD), an organic light emitting diode (OLED), a flat panel display, or a solid-state display. It is appreciated that the video/graphics display device 146 may be wired or wireless and may be an external video/graphics display device 146 that allows a user to increase the desktop area by extending the desktop in an embodiment. Additionally, as described herein, the information handling system 100 may include or be operatively coupled to a cursor control device (e.g., a trackpad 152, or gesture or touch screen input), a stylus 150, and/or a keyboard 148, among others that allows the user to interface with the information handling system 100 via the video/graphics display device 146. Information handling system 100 may also be operatively coupled to a wired or wireless input/output device 144 such as the wireless peripheral device 156 or other hardware devices that may include a hardware processing device such as a hardware processor, microcontroller, or other hardware processing resource. Various drivers and hardware control device electronics may be operatively coupled to operate the I/O devices 144 according to the embodiments described herein. The present specification contemplates that the I/O devices 144 may be wired or wireless.

A network interface device of the information handling system 100 may be wired or wireless such as shown with wireless interface adapter 130 that can provide wireless connectivity among devices such as with Bluetooth® or to a network 138, e.g., a wide area network (WAN), a local area network (LAN), wireless local area network (WLAN), a wireless personal area network (WPAN), a wireless wide area network (WWAN), or other network. In embodiments described herein, the wireless interface device 130 with its radio 132, RF front end 134 and antenna 136 is used to communicate with the wireless peripheral devices including the wireless peripheral device 156 described herein, via, for example, a Bluetooth® or Bluetooth® Low Energy (BLE) protocols or any proprietary RF protocol such as those may utilize similar frequency ranges but proprietary modulation and data transmission characteristics. In embodiments, Bluetooth®, BLE, proprietary RF protocol, or other WPAN or WLAN protocols and plural such protocols may be used for communication with and among a wireless peripheral device 156 or any other wireless peripheral device to be paired with the information handling system 100 or other information handling systems.

In other embodiments, a WAN, WWAN, LAN, and WLAN may each include an AP 140 or base station 142 used to operatively couple the information handling system 100 to a network 138 via a wireless interface adapter 130. In a specific embodiment, the network 138 may include macro-cellular connections via one or more base stations 142 or a wireless AP 140 (e.g., Wi-Fi), or such as through licensed or unlicensed WWAN small cell base stations 142. Connectivity may be via wired or wireless connection. For example, wireless network wireless APs 140 or base stations 142 may be operatively connected to the information handling system 100. Wireless interface adapter 130 may include one or more RF (RF) subsystems (e.g., radio 132) with transmitter/receiver circuitry, modem circuitry, one or more antenna RF (RF) front end circuits 134, one or more wireless controller circuits, amplifiers, antennas 136 and other circuitry of the radio 132 such as one or more antenna ports used for wireless communications via multiple radio access technologies (RATs). The radio 132 may communicate with one or more wireless technology protocols.

In an embodiment, the wireless interface adapter 130 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WiMAX, WWAN such as 3GPP or 3GPP2, Bluetooth® standards, proprietary RF protocol, or similar wireless standards may be used. Utilization of radiofrequency communication bands according to several example embodiments of the present disclosure may include bands used with the WLAN standards which may operate in both licensed and unlicensed spectrums. For example, WLAN may use frequency bands such as those supported in the 802.11 ah/j/n/ac/ax/be including Wi-Fi 6, Wi-Fi 6e, and the emerging Wi-Fi 7 standard. It is understood that any number of available channels may be available in WLAN under the 2.4 GHz, 5 GHz, or 6 GHz bands which may be shared communication frequency bands with WWAN protocols or Bluetooth® protocols in some embodiments. Wireless interface adapter 130 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 130 can represent an add-in card, wireless network interface module that is integrated with a main board of the information handling system 100 or integrated with another wireless network interface capability, or any combination thereof.

In some embodiments, software, firmware, dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software programs executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes computer-readable code instructions, parameters, and profiles 114 or receives and executes instructions, parameters, and profiles 114 responsive to a propagated signal, so that a hardware device connected to a network 138 may communicate voice, video, or data over the network 138. Further, the instructions 114 may be transmitted or received over the network 138 via the network interface device or wireless interface adapter 130.

The information handling system 100 may include a set of instructions 114 that may be executed to cause the computer system to perform any one or more of the methods or computer-based functions disclosed herein. For example, instructions 114 may be executed by a hardware processor 102, GPU 106, EC 104 or any other hardware processing resource and may include software agents, or other aspects or components used to execute the methods and systems described herein. Various software modules comprising application instructions 114 may be coordinated by an OS 118, and/or via an application programming interface (API) include a unified device API described herein. An example OS 118 may include Windows®, Android® and other OS types. Example APIs may include Win 32, Core Java API, or Android APIs.

In an embodiment, the information handling system 100 may include a disk drive unit 122. The disk drive unit 122 and may include machine-readable code instructions, parameters, and profiles 114 in which one or more sets of machine-readable code instructions, parameters, and profiles 114 such as firmware or software can be embedded to be executed by the hardware processor 102 or other hardware processing devices such as a GPU 106 or EC 104, or other microcontroller unit to perform the processes described herein. Similarly, main memory 108 and static memory 110 may also contain a computer-readable medium for storage of one or more sets of machine-readable code instructions, parameters, or profiles 114 described herein. The disk drive unit 122 or static memory 110 also contain space for data storage. Further, the machine-readable code instructions, parameters, and profiles 114 may embody one or more of the methods as described herein. In a particular embodiment, the machine-readable code instructions, parameters, and profiles 114 may reside completely, or at least partially, within the main memory 108, the static memory 110, and/or within the disk drive 122 during execution by the hardware processor 102, EC 104, or GPU 106 of information handling system 100.

Main memory 108 or other memory of the embodiments described herein may contain computer-readable medium (not shown), such as RAM in an example embodiment. An example of main memory 108 includes random access memory (RAM) such as static RAM (SRAM), dynamic RAM (DRAM), non-volatile RAM (NV-RAM), or the like, read only memory (ROM), another type of memory, or a combination thereof. Static memory 110 may contain computer-readable medium (not shown), such as NOR or NAND flash memory in some example embodiments. The applications and associated APIs, for example, may be stored in static memory 110 or on the disk drive unit 122 that may include access to a machine-readable code instructions, parameters, and profiles 114 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 124 (a.k.a. a power supply unit (PSU)). The PMU 124 may include a hardware controller and executable machine-readable code instructions to manage the power provided to the components of the information handling system 100 such as the hardware processor 102 and other hardware components described herein. The PMU 124 may control power to one or more components including the one or more drive units 122, the hardware processor 102 (e.g., CPU), the EC 104, the GPU 106, a video/graphic display device 146, or other wired I/O devices 144 such as the mouse 154, the stylus 150, the keyboard 148, and the trackpad 152 and other components that may require power when a power button has been actuated by a user. In an embodiment, the PMU 124 may monitor power levels and be electrically coupled to the information handling system 100 to provide this power. The PMU 124 may be coupled to the bus 120 to provide or receive data or machine-readable code instructions. The PMU 124 may regulate power from a power source such as the battery 126 or AC power adapter 128. In an embodiment, the battery 126 may be charged via the AC power adapter 128 and provide power to the components of the information handling system 100, via wired connections as applicable, or when AC power from the AC power adapter 128 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 110 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described herein, the information handling system 100 may be paired with and operatively coupled to a wireless peripheral device 156. The wireless peripheral device 156 may be any type of peripheral device and may include a wireless mouse 154, a wireless stylus 150, a wireless keyboard 148, a wireless video display device 146, among other wireless peripheral devices. The wireless peripheral device 156 may include a wireless peripheral device hardware microcontroller 158 to execute computer-readable program code instructions described herein. Additionally, the wireless peripheral device 156 includes a peripheral device power management unit (PMU) 180. The peripheral device PMU 180 may include a hardware controller and executable machine-readable code instructions to manage the power provided to the components of the wireless peripheral device 156 such as the wireless peripheral device radio 184, the peripheral device storage device 160, and the peripheral device microcontroller 158 as well as other hardware components described herein. In an embodiment, the peripheral device PMU 180 may monitor power levels and be electrically coupled to the wireless peripheral device 156 to provide this power. The peripheral device PMU 180 may regulate power from a power source such as a wireless peripheral device battery 182.

In an embodiment, the wireless peripheral device 156 is operatively couplable to the information handling system 100, via a dongle 190. In an embodiment, as power is provided to the wireless peripheral device hardware microcontroller 158 and wireless peripheral device radio 184 by operation of the peripheral device PMU 180, the wireless peripheral device 156 may transceive data to and from the information handling system 100 via the wireless peripheral device RF front end 186 and wireless peripheral device antenna 188. Additionally, in order to transceive data to and from the wireless peripheral device 156, the dongle 190 also includes a built-in dongle radio 192, dongle RF front end 194, and dongle antenna 196 which may also power from the information handling system, such as via a universal serial bus (USB) port coupling. As such, as the wireless peripheral device 156 is initiated and the dongle 190 has been inserted into, for example, a USB port of the information handling system 100, the wireless peripheral device 156 may communicate with the information handling system 100. It is appreciated that the wireless peripheral device 156 may communicate wirelessly with the dongle 190 using any radio frequency including 2.4 GHz and 5 GHz frequency bands. In an embodiment, the wireless protocol used to operatively couple the dongle 190 to the wireless peripheral device may be a proprietary wireless radio frequency (RF) protocol involving proprietary modulation, functions, and wireless data transmission capabilities.

As described herein, as the wireless peripheral device 156 is operatively coupled to the information handling system 100 via the dongle 190, the wireless peripheral device hardware microcontroller 158 may execute computer-readable program code instructions of silent channel provisioning module 162 to establish silent pairing between the wireless peripheral device 156 and the information handling system 100 via a plurality of communication channels available at the wireless peripheral device. Each communication channel may be silently paired for communication according to one of a plurality of wireless communication protocols, including Bluetooth®, BLE, WLAN, and proprietary RF protocols. In an embodiment, the hardware microcontroller 158 may execute computer-readable program code of a silent channel provisioning module 162 to, where the dongle 190 is detected, request Bluetooth® or BLE pairing (BT pairing) pre-authorization data from the information handling system 100 to generate Bluetooth® or BLE pairing (BT pairing) data and establish a Bluetooth® or BLE wireless connection with the information handling system 100 at one of a plurality of wireless communication channels (e.g., 178-2) dedicated to transceiving data according to the BT or BLE communication protocol. Hereinafter, Bluetooth® or BLE pairing pre-authorization data may be referred to as BT pairing pre-authorization data and generated Bluetooth® or BLE pairing data may be referred to BT pairing data in embodiments herein. This BT pairing data in an embodiment may include a secure BT host address of the information handling system 100 or the dongle 190, a pairing passcode seed, a session identification value, a time stamp, or other security credentials necessary to establish a trusted relationship between the information handling system 100 and the wireless peripheral device 156. The hardware microcontroller 158 may execute computer-readable program code of the silent channel provisioning module 162 to request and receive such BT pairing pre-authorization data via a wireless link already established via the dongle 190 at a secure BT host address specific to the dongle 190, which may be a trusted device for communication between the information handling system 100 and the wireless peripheral device 156. Thus, the systems and methods described herein may provide for the provisioning of one or more wireless communication channels (e.g., 178-1, 178-2, or 178-n) associated with an RF dongle 190 connected to the information handling system 100, or a BT or BLE wireless link, via silent pairing processes.

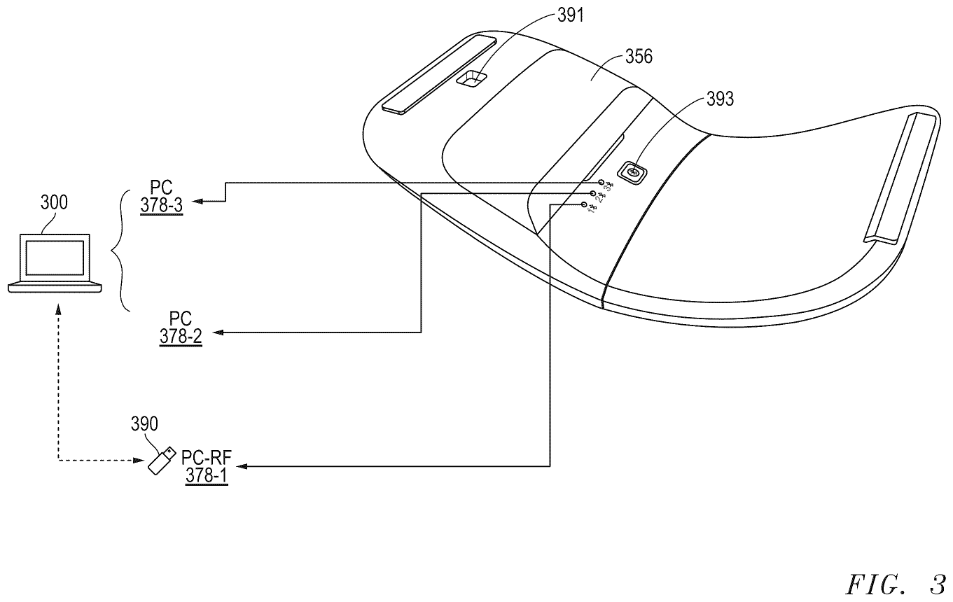

In an example embodiment, the wireless peripheral device 156 includes a plurality of parallel communication channels (shown in FIG. 3 below) that are paired and may be automatically chosen for active use by an automatic wireless connection switching module 163 at the information handling system, via remote control with other-the-air messaging, or may be manually selected via manual channel selection buttons (shown in FIG. 3 below) formed on the housing of the wireless peripheral device 156. The automatic wireless connection switching module 163 allows the information handling system to transmit instructions to the wireless peripheral device 156, via over-the-air messaging such as BLE generic attribute profile (GATT) messaging to toggle through the first wireless communication channel 178-1, the second wireless communication channel 178-2, and any nth wireless communication channel 178-n, depending on the availability of each channel pre-paired under another wireless communication protocol and able to establish a wireless link between the information handling system 100 and the wireless peripheral device 156 and based on pre-defined priorities for establishing wireless links according to one communication protocol over another.

For example, the user or an internet technology decision maker (ITDM) for an enterprise may set the automatic wireless connection switching module 163 of the information handling system 100 to prioritize a preferred wireless link established via the dongle 190 over any other wireless communication protocols, such as Bluetooth®, BLE, or other WLAN connections. In another example, the user or an ITDM may set the automatic wireless connection switching module 163 and a corresponding agent 163a at the wireless peripheral device to work in tandem to identify a next best alternative wireless communication protocol that is paired in parallel to be used to establish a wireless link between the information handling system and the wireless peripheral device when the preferred wireless link (e.g., proprietary RF wireless link established via the dongle 190) is unavailable. As yet another example, the user or an ITDM may set the automatic wireless connection switching module 163 and a corresponding agent 163a at the wireless peripheral device to work in tandem, via over-the-air messaging to assess which of a plurality of available wireless communication protocols are currently transceiving data at a highest data rate, a lowest interference level (relative signal strength indicator (RSSI)), BLE high accuracy data measurement (HADM) for proximity, or with the fewest dropped packets.

The first wireless communication channel 178-1 may thus be selected by the automatic wireless connection switching module 163 to cause the wireless peripheral device 156 to communicate with the information handling system 100 via the dongle 190 using a first wireless communication protocol at a specific radio frequency. In an embodiment, this first wireless communication protocol used for communication via the dongle 190 may be a preferred wireless link that the automatic wireless connection switching module 163 and a corresponding agent 163a at the wireless peripheral device work in tandem to scan for, detect when present, and automatically switch over to when such presence is detected. Similarly, the selection of the second wireless communication channel 178-2 by the automatic wireless connection switching module 163 causes the wireless peripheral device 156 to communicate with the information handling system 100 without using the dongle 190 while using a second wireless communication protocol such as a BT or Bluetooth® Low Energy (BLE) communication protocol at another specific radio frequency. Any other nth wireless communication channel 178-n may also be selected by the automatic wireless connection switching module 163 to cause the wireless peripheral device 156 to communicate with the information handling system 100 without using the dongle 190 while using a third wireless communication protocol at yet another specific radio frequency, such as a wireless local area network (WLAN) wireless link in the 2.4 GHz, 5 GHz, or 6 GHz frequency ranges.

By way of example, the dongle 190 may be operatively coupled to a USB port of a docking station 145, external display device 146, or other intervening device associated with the information handling system 100. As the information handling system 100 is operatively coupled to the docking station 145, the wireless peripheral device 156, via the dongle 190, may communicate with the information handling system 100 using the first communication protocol that may be the proprietary RF protocol due to the dongle 190 acting as an intermediary communication device. The automatic wireless connection switching module 163 may detect the dongle 190 at the docking station 145 in an example embodiment. However, in instances where the user, even temporarily, leaves the docking station 145 and dongle 190 by physically carrying away the wireless peripheral device 156 and information handling system 100, the dongle 190 is no longer available to act as this intermediary communication device. In this instance, the wireless peripheral device hardware microcontroller 158 may detect that the dongle 190 is no longer available to use as this intermediary communication device and may establish a secondary wireless link on a channel previously silently paired to the information handling system 100 according to a next best alternative wireless communication protocol via the wireless communication channel 178-2. This allows the user to still operate the wireless peripheral device 156 with the information handling system 100 even where the dongle 190 is no longer available. This further allows the user to not have the dongle 190 occupy a USB port at the information handling system 100 and still have the wireless peripheral device 156 operate as an input device when the dongle 190 at the docking station is not available. As a consequence, the USB port at the information handling system 100 that would have otherwise been occupied by the dongle 190 is now free to be used by another peripheral device while the dongle 190 remains at the USB port of the docking station.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

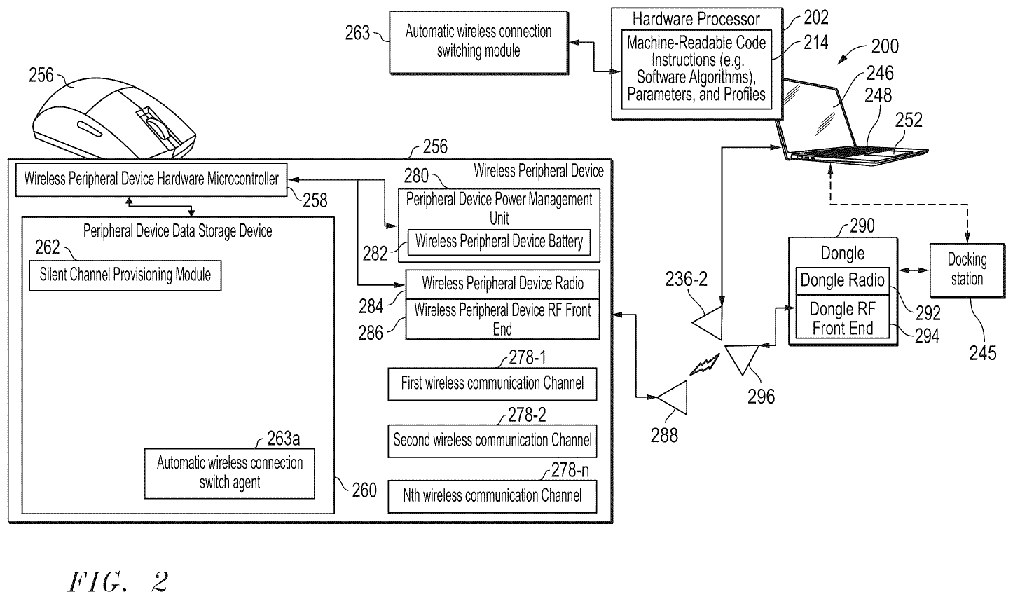

FIG. 2 is a graphic and block diagram illustrating an information handling system 200 that may be operatively coupled to a wireless peripheral device 256 that includes an automatic wireless connection switching agent 263a to establish a wireless link with an information handling system via one of a plurality of wireless communication channels 278-1, 278-1, 278-n, based on prioritization by a user or an internet technology decision maker (ITDM) of an available wireless communication protocol over others according to another embodiment of the present disclosure. FIG. 2 shows that the wireless peripheral device 256 is a wireless mouse such as a wireless mouse similar to that shown in FIG. 1. However, the present specification contemplates that the wireless peripheral device 256 may be any type of peripheral device such as a wireless stylus, a wireless keyboard, a wireless video display device, among other wireless peripheral devices.

The information handling system 200 includes a built-in video display device 246, a built-in keyboard 248, and a built-in trackpad 252. Other types of information handling systems, such as tablets, all-in-one systems, and others, are contemplated for wireless pairing with the wireless peripheral device 256 in other embodiments. Additionally, the information handling system 200 includes a hardware processor 202, and machine-readable code instructions 214 to execute the computer-readable program code instructions described herein.

The wireless peripheral device 256 may include a wireless peripheral device hardware microcontroller 258 to execute computer-readable program code instructions described herein. Additionally, the wireless peripheral device 256 includes a peripheral device power management unit (PMU) 280. The peripheral device PMU 280 may include a hardware controller and executable machine-readable code instructions to manage the power provided to the components of the wireless peripheral device 256 such as the wireless peripheral device radio 284, the peripheral device storage device 260, and the peripheral device microcontroller 258 as well as other hardware components described herein. In an embodiment, the peripheral device PMU 280 may monitor power levels and be electrically coupled to the wireless peripheral device 256 to provide this power. The peripheral device PMU 280 may regulate power from a power source such as a wireless peripheral device battery 282.

In an embodiment, as power is provided to the wireless peripheral device hardware microcontroller 258 and wireless peripheral device radio 284 by operation of the peripheral device PMU 280, the wireless peripheral device 256 may have an additional capacity to wirelessly transceive data to and from the information handling system 200 via the wireless peripheral device RF front end 286 and wireless peripheral device antenna 288. Information handling system 200 may transceive data to and from the wireless peripheral device 256 via antenna 236-2 as described above or via a dongle 290 in embodiments herein. Pairing with the wireless peripheral device 256 may be in parallel via silent pairing as with the antenna 236-2 and the dongle 290 with dongle antenna 296. Additionally, in order to transceive data to and from the wireless peripheral device 256, the dongle 290 also includes a built-in dongle radio 292, dongle RF front end 294, and dongle antenna 296, as described in embodiments herein. As such, as the wireless peripheral device 256 is initiated and the dongle 290 has been inserted into, for example, a USB port of the information handling system 200, or an intermediary docking station or other device, the wireless peripheral device 256 may communicate with the information handling system 200. It is appreciated that the wireless peripheral device 256 may communicate wirelessly with the dongle 290 using any radio frequency including 2.4 GHz and 5 GHz frequency bands. In an embodiment, the wireless protocol used to operatively couple the dongle 290 to the wireless peripheral device may be a proprietary RF wireless protocol including proprietary wireless modulation and having proprietary capabilities or methods for wireless transmission and reception of data.

In an embodiment, the wireless peripheral device 256 is operatively coupled to the information handling system 200, at least initially, via a dongle 290. In an embodiment, as power is provided to the wireless peripheral device hardware microcontroller 258 and wireless peripheral device radio 284 by operation of the peripheral device PMU 280, the wireless peripheral device 256 may transceive data to and from the information handling system 200 via the wireless peripheral device RF front end 286 and wireless peripheral device antenna 288. Additionally, in order to transceive data to and from the wireless peripheral device 256, the dongle 290 also includes a built-in dongle radio 292, dongle RF front end 294, and dongle antenna 296 which may also power from the information handling system 200, such as via a universal serial bus (USB) port coupling. As such, as the wireless peripheral device 256 is initiated and the dongle 290 has been inserted into, for example, a USB port of the information handling system 200, the wireless peripheral device 256 may communicate with the information handling system 200. It is appreciated that the wireless peripheral device 256 may communicate wirelessly with the dongle 290 using any radio frequency including 2.4 GHz and 5 GHz frequency bands. In an embodiment, the wireless protocol used to operatively couple the dongle 290 to the wireless peripheral device may be the proprietary wireless protocol involving proprietary modulation, functions, and wireless data transmission capabilities. In an embodiment, the dongle 290 may be preprogrammed with pairing authentication data that is used to automatically wirelessly pair and bond the dongle 290 with the wireless peripheral device 256.

As described herein, as the wireless peripheral device 256 is operatively coupled to the information handling system 200 via the dongle 290, the wireless peripheral device hardware microcontroller 258 may execute computer-readable program code instructions of a silent channel provisioning module 262 to request, automatically, Bluetooth® (BT) pairing pre-authorization data from the information handling system 200 on top of or in addition to the proprietary RF protocol pairing via the dongle. After the BT pairing pre-authorization data has been exchanged via the dongle 290 to and from the wireless peripheral device 256 and information handling system 200, each of the hardware processor 202 and wireless peripheral device hardware microcontroller 258 may execute a minimal touch pairing mechanism such as a Dell Pair system, using the pre-loaded BT pairing credentials, seed values or the like, as given within the BT pairing pre-authorization data or generated using such BT pairing pre-authorization data to pair the wireless peripheral device 256 and the information handling system 200 via BT or BLE wireless communication protocol.

In an embodiment, the wireless peripheral device hardware microcontroller 258 executes the computer-readable program code of the silent channel provisioning module 262 to dedicate at least one of a first wireless communication channel 278-1, a second wireless communication channel 278-2, or any nth wireless communication channel 278-n to communication using wireless links established according to each of the proprietary RF wireless communication protocol, and the BT or BLE communication protocol using the silent pairing techniques described directly above. The dedication of the BT pairing data to a specific wireless communication channel (e.g., 278-2) allows the wireless peripheral device 256 to alternatively communicate with the information handling system 200 without the use of the dongle 290 while using the wireless communication channel 278-2. This allows the wireless peripheral device 256 to automatically switch from a communication with the information handling system 200 using the first (e.g., proprietary RF) communication protocol on a first wireless communication channel 278-1 via the dongle 290 to communicating with the information handling system 200 using another wireless protocol such as a BT or BLE communication protocol on a second wireless communication channel 278-2, or any nth wireless communication channel 278-n.

As described herein, the wireless peripheral device hardware microcontroller 258 may execute computer-readable program code instructions, via over-the-air messaging such as BLE GATT messaging of the automatic wireless connection switching agent 263a to establish a wireless link between the wireless peripheral device 256 and the information handling system 200 via a plurality of communication channels available at the wireless peripheral device. Each communication channel may be established for communication according to one of a plurality of wireless communication protocols, including Bluetooth®, BLE, WLAN, and proprietary RF protocols. In an example embodiment, the wireless peripheral device 256 includes a plurality of communication channels (shown in FIG. 3 below) that may be automatically chosen for active use by an automatic wireless connection switching module 263 at the information handling system, or may be manually selected via manual channel selection buttons (shown in FIG. 3 below) formed on the housing of the wireless peripheral device 256. The automatic wireless connection switching module 263 allows the information handling system 200 to transmit instructions to the wireless peripheral device 256 to toggle through the first wireless communication channel 278-1, the second wireless communication channel 278-2, and any nth wireless communication channel 278-n, depending on the availability of each channel to establish a wireless link between the information handling system 200 and the wireless peripheral device 256 and based on pre-defined priorities for establishing wireless links according to one communication protocol over another. Such over-the-air messaging may be executed using a secure extended direct GATT communication transmitted directly to a secure BLE wireless peripheral device address that is specific to the wireless peripheral device 256 or as part of GATT messaging when a Bluetooth® or BLE wireless link is otherwise established. This effectively allows the information handling system 200 to remotely control automatic switching among a plurality of wireless communication channels 278-1, 278-2, to 278-n for the wireless peripheral device 256.

For example, the user or an internet technology decision maker (ITDM) for an enterprise may set the automatic wireless connection switching agent 263a of the wireless peripheral device 256 to prioritize a preferred wireless link established via the dongle 290 over any other wireless communication protocols, such as Bluetooth®, BLE, or other WLAN connections. In another example, the user or an ITDM may set the automatic wireless connection switching agent 263a at the wireless peripheral device 256 to work in tandem to identify one a next best alternative wireless communication protocol to be used to establish a wireless link between the information handling system and the wireless peripheral device when the preferred wireless link (e.g., proprietary RF wireless link established via the dongle 290) is unavailable. As yet another example, the user or an ITDM may set the automatic wireless connection switching agent 263a at the wireless peripheral device to work in tandem to assess which of a plurality of available wireless communication protocols are currently transceiving data at a highest data rate, a lowest interference level (relative signal strength indicator (RSSI)), HADM signal proximity, or with the fewest dropped packets.

The first wireless communication channel 278-1 may thus be selected by the automatic wireless connection switching agent 263a to cause the wireless peripheral device 256 to communicate with the information handling system 200 via the dongle 290 using a first wireless communication protocol, such as a proprietary RF protocol, at a specific radio frequency. In an embodiment, this first wireless communication protocol used for communication via the dongle 290 may be a preferred wireless link that the automatic wireless connection switching agent 263a at the wireless peripheral device scans for, detects when present, and automatically switches over to when such presence is detected. Similarly, the selection of the second wireless communication channel 278-2 causes the wireless peripheral device 256 to communicate with the information handling system 200 without using the dongle 290 while using a second wireless communication protocol such as a BT or Bluetooth® Low Energy (BLE) communication protocol at another specific radio frequency, via switching as communicated over-the-air. Any other nth wireless communication channel 278-n may also be selected by the automatic wireless connection switching agent 263a to cause the wireless peripheral device 256 to communicate with the information handling system 200 without using the dongle 290 while using a third wireless communication protocol at yet another specific radio frequency, such as a wireless local area network (WLAN) wireless link in the 2.4 GHz, 5 GHz, or 6 GHz frequency ranges.

By way of an example, the dongle 290 may be operatively coupled to a USB port of a docking station 291 associated with the information handling system 200. When the information handling system 200 is operatively coupled to the docking station 245, the wireless peripheral device 256, via the dongle 290, may communicate with the information handling system 200 using the first communication protocol that may be the proprietary RF protocol due to the dongle 290 acting as an intermediary communication device. However, in instances where the user, even temporarily, leaves the docking station 245 and dongle 290 by physically carrying away the wireless peripheral device 256 and information handling system 200, the dongle 290 is no longer available to act as this intermediary communication device. In this instance, the wireless peripheral device hardware microcontroller 258 may detect that the dongle 290 is no longer available to use as this intermediary communication device and may access the BT pairing data preauthorized at the first virtual pairing slot 270, and utilizing the wireless communication channel 278-1, generated earlier to establish at BT or BLE wireless connection with the information handling system 200. This allows the user to still operate the wireless peripheral device 256 with the information handling system 200 even where the dongle 290 is no longer available. This further allows the user to not have the dongle 290 occupy a USB port at the information handling system 200 and still have the wireless peripheral device 256 operate as an input device when the dongle 290 at the docking station is not available. As a consequence, the USB port at the information handling system 200 that would have otherwise been occupied by the dongle 290 is now free to be used by another peripheral device while the dongle 290 remains at the USB port of the docking station.

In an embodiment, the hardware processor 202 of the information handling system 200 executing code instructions of the automatic wireless connection switching module 263 may determine whether the wireless communication dongle 290 has been operatively coupled to the information handling system 200. Such a dongle, in an embodiment, may be capable of wireless communication via a proprietary radio frequency (RF) wireless communication protocol on the first wireless communication channel 278-1. If the dongle is not detected at the information handling system 200, this may indicate that wireless communication with the wireless peripheral device 256 via the dongle 290 is not currently available, and the hardware processor 202 of the information handling system 200 executing code instructions of the automatic wireless connection switching module 263 may transmit a BLE GATT communication or other OTA message via antenna 236-2 to the wireless peripheral device 256 switch to the second wireless communication channel 278-2 to establish a wireless link directly with antenna 236-2 using an already-paired, available, parallel wireless communication protocol on that second wireless communication channel 278-2. For example, the wireless radio of the information handling system may send a BLE GATT communication or other OTA message to switch to the second wireless communication channel and to establish a wireless link with the wireless peripheral device according to the BT, BLE, or one of various Wi-Fi WLAN wireless connections in any number of frequency ranges, such as 2.4 GHz, 5 GHz, or 6 GHz.

The hardware processor 202 of the information handling system 200 in an embodiment may continue to detect the presence of the dongle 290. As described herein, execution of code instructions of the automatic wireless connection switching module 263 at the information handling system 200 may scan for and detect a dongle 290 and transmit an OTA communication or instruction to a corresponding agent 263-a at the wireless peripheral device 256 in an embodiment. The automatic wireless connection switching agent 263-a at the wireless peripheral device 256 may work in tandem to automatically switch over to the first wireless communication channel 278-1 for the proprietary RF protocol to communicate using a wireless link via the dongle 290 when presence of the dongle 290 is detected. While scanning for or waiting for detection of the dongle 290, the information handling system 200 and the wireless peripheral device 256 may continue to communicate wirelessly via the pre-paired BLE or BT wireless link established using the second wireless communication channel 278-2 dedicated to the BLE wireless communication protocol.

If the dongle 290 is detected at the information handling system 200, docking station, external display device or other intermediate device, establishing a wireless link with the wireless peripheral device 256 via the dongle 290 may be possible. In such a case, the hardware processor 202 of the information handling system 200 executing code instructions of the automatic wireless connection switching module 263 may determine whether the information handling system 200 is currently in wireless communication with the wireless peripheral device 256 according to a wireless communication protocol (e.g., Bluetooth® (BT), Bluetooth® Low Energy (BLE), wide area local network (WLAN) Wi-Fi other than the proprietary RF protocol supported by the dongle 290. If the information handling system 290 is already in wireless communication with the wireless peripheral device 256 via such another wireless communication protocol, the information handling system 200 may transmit, via the already established wireless link with the wireless peripheral device 256 at the second wireless communication channel 278-2, instructions to the automatic wireless connecting switching agent 263-a at the wireless peripheral device 256 to switch communications over to a wireless link established via the dongle 290 on the first wireless communication channel 278-1.

If the information handling system 200 is not already in wireless communication with the wireless peripheral device 256 via such another wireless communication protocol, the information handling system 200 may transmit, via secure extended directed generic attribute profile (GATT) communication, or GATT messaging at a BLE host address specific to the wireless peripheral device 256 in an embodiment, instructions to the automatic wireless connecting switching agent 263-a at the wireless peripheral device 256 to switch communications over to a proprietary RF protocol wireless link established on a silently paired first wireless communication channel 278-1 via the dongle 290. The information handling system 200 may then continue to detect presence of the dongle 290 while the wireless peripheral device 256 maintains communication through the proprietary RF protocol on the first wireless communication channel 278-1 via the dongle 490.

If the dongle is removed, and the information handling system 200 does not detect the dongle 290 at the information handling system 200, docking station, external display, or other intermediate device, the information handling system 200 may execute code instructions of the automatic wireless connecting switching module 263 to determine a different, parallel, silently paired alternative wireless communication protocol. As described herein, the user or an ITDM may set the automatic wireless connection switching module 263 to identify a next best alternative wireless communication protocol (e.g., BT, BLE, WLAN in a specific RF band such as 2.5 GHz, 5 GHz, or 6 GHz) to be used to establish a wireless link between the information handling system 200 and the wireless peripheral device 256 when the preferred proprietary RF protocol wireless link to the dongle 290 using the first wireless communication channel 278-1 is unavailable. If a next best alternative wireless communication protocol has not been predefined, the hardware processor 202 for the information handling system 200 executing code instructions of the automatic wireless connecting switching module 263 may transmit a GATT communication or other OTA communication instruction to direct the wireless peripheral device 256 to switch to a silently paired, parallel wireless link on the second or third wireless communication channels 278-2 or 278-3, respectively, according to a default wireless communication protocol, or a last used wireless communication channel that supports a wireless protocol other than the proprietary RF protocol, such as BT or BLE.

Alternatively, in an embodiment in which a next best alternative wireless communication protocol has been predefined, the hardware processor 202 for the information handling system 200 executing code instructions of the automatic wireless connecting switching module 236 may transmit a GATT communication or other OTA communication instruction to direct the wireless peripheral device 256 to switch to a silently paired, parallel wireless link on the third wireless communication channel 278-3 dedicated to wireless communication using the predefined next best alternative wireless communication protocol, such as Wi-Fi, for example.

FIG. 3 is a graphic diagram of a wireless peripheral device 356 having a plurality of wireless communication channels 378-1, 378-2, 378-3 to which an information handling systems 300 may be operatively coupled to according to an embodiment of the present disclosure. FIG. 3 shows that the wireless peripheral device 356 is a wireless mouse (turned upside down in the image shown) such as a wireless mouse similar to that shown in FIGS. 1 and 2. However, the present specification contemplates that the wireless peripheral device 356 may be any type of peripheral device such as a wireless stylus, a wireless keyboard, a wireless video display device, among other wireless peripheral devices.

In the embodiment shown in FIG. 3, the wireless peripheral device 356 is a wireless mouse with a LED/laser optical detector system 391. The LED/laser optical detector system 391 is used to detect when the wireless mouse is moved. It is appreciated that this example wireless mouse is used as an example of the wireless peripheral device 356 may also include any number of input devices such as buttons (not shown), scrolling wheels (not shown), and other input devices that allow a user to provide input to an information handling system 300 as described herein.

The wireless peripheral device 356 also includes a manual channel selection button 393. The manual channel selection button 393 allows a user to toggle between a first wireless communication channel 378-1 (e.g., a radio frequency (RF) protocol wireless communication channel), a second wireless communication channel 378-2 (e.g., BT1m₃), and a third wireless communication channel 378-3 (e.g., BT1m₄). It is appreciated that although three wireless communication channels 378-1, 378-2, 378-3 are shown in FIG. 3, the wireless peripheral device 356 may include any number of wireless communication channels 378-1, 378-2, 378-3 and the present specification contemplates that more or fewer wireless communication channels 378-1, 378-2, 378-3 may be provisioned at the wireless peripheral device 356 for the user to toggle between.

As described herein, the wireless communication channels 378-1, 378-2, 378-3 allow a user to pair the wireless peripheral device 356 to an information handling system 300 on plural parallel channels 378-1, 378-2, 378-3, according to embodiments of the present disclosure. FIG. 3 shows that the first wireless communication channel 387-1 is used to communicate with the information handling system 300 via the dongle 390 using a first wireless communication protocol at a specific radio frequency, such as with a proprietary RF protocol as described herein. In an embodiment, this first wireless communication protocol may be a proprietary RF wireless communication protocol to the manufacturer of the dongle 390 and wireless peripheral device 356 and provide for proprietary modulation, wireless data transfer, pairing techniques and other characteristics for the proprietary RF protocol.

In an embodiment, the selection of the second wireless communication channel 378-2 by the user causes the wireless peripheral device 356 to communicate with the information handling system 300 without using the dongle 390 while using a second wireless communication protocol such as a BT or Bluetooth® Low Energy (BLE) communication protocol or other communication protocol at another specific radio frequency. The selection of the third wireless communication channel 378-3 in an embodiment by the user also causes the wireless peripheral device 356 to communicate with the information handling system 300 without using the dongle 390 while using a third wireless communication protocol such as a BT or Bluetooth® Low Energy (BLE) communication protocol or other communication protocol at another specific radio frequency. It is appreciated that, in some embodiments, the differences between the wireless protocols used at the first wireless communication channel 378-1 and the second wireless communication channel 378-2 or third wireless communication channel 378-3 are a result of the first wireless communication channel 378-1 using the dongle 390 to communicate with the information handling system 300. Thus, the wireless peripheral device 356 may automatically switch from a communication with the information handling system 300 using the first (e.g., proprietary) communication protocol via the dongle 390 to communicating with the information handling system 300 using another wireless protocol such as a BT or BLE communication protocol on a parallel, silently-paired wireless communication channel 378-2 or 378-3.

In an embodiment, the wireless peripheral device 356 is operatively coupled to the information handling system 300, at least initially, via a dongle 390. In an embodiment, the wireless peripheral device 256 may transceive data to and from the information handling system 300 via the wireless communication channel 378-1. As such, as the wireless peripheral device 356 is initiated and the dongle 390 has been inserted into, for example, a USB port of the information handling system 300, the wireless peripheral device 356 may communicate with the information handling system 300. It is appreciated that the wireless peripheral device 256 may communicate wirelessly with the dongle 390 using any radio frequency including 2.4 GHz and 5 GHz frequency bands. In an embodiment, the dongle 390 and the wireless peripheral device 356 may be preprogrammed with pairing authentication data that is used to automatically wirelessly pair and bond the dongle 390 with the wireless peripheral device 356.

As described herein, as the wireless peripheral device 356 is operatively coupled to the information handling system 300 via the dongle 390, the wireless peripheral device 356 may request, automatically, Bluetooth® (BT) pairing pre-authorization data from the information handling system 300 on top of or in addition to the proprietary RF protocol pairing via the dongle. After the BT pairing pre-authorization data has been exchanged via the dongle 390 to and from the wireless peripheral device 356 and information handling system 300, each of the wireless peripheral device 356 and the information handling system 300 may execute a minimal touch pairing mechanism such as a Dell Pair system, using the pre-loaded BT pairing credentials, seed values or the like, as given within the BT pairing pre-authorization data or generated using such BT pairing pre-authorization data to pair the wireless peripheral device 356 and the information handling system 300 via BT or BLE wireless communication protocol. This may occur silently in the background while the information handling system 300 continues to communicate wireless with the wireless peripheral device 356 via the proprietary RF protocol wireless link dedicated to the wireless communication channel 378-1.

In an embodiment, the wireless peripheral device 356 may dedicate at least one of a first wireless communication channel 378-1, a second wireless communication channel 378-2, or any nth wireless communication channel 378-n to communication using wireless links established according to each of the proprietary RF wireless communication protocol, and the BT or BLE communication protocol using the silent pairing techniques described directly above. The dedication of the BT pairing data to a specific wireless communication channel (e.g., 378-2) allows the wireless peripheral device 356 to alternatively communicate with the information handling system 300 without the use of the dongle 390 while using the wireless communication channel 378-2. This allows the wireless peripheral device 356 to automatically switch from a communication with the information handling system 300 using the first (e.g., proprietary RF) communication protocol via the dongle 390 to communicating with the information handling system 300 using another wireless protocol such as a BT or BLE communication protocol. As described herein, the wireless peripheral device 356 may execute computer-readable program code instructions, via over-the-air messaging such as BLE GATT messaging to establish a wireless link between the wireless peripheral device 356 and the information handling system 300 via a plurality of communication channels available at the wireless peripheral device. Such over-the-air messaging may be executed using a secure extended direct GATT communication transmitted directly to a secure BLE wireless peripheral device address that is specific to the wireless peripheral device 356. This effectively allows the information handling system 300 to remotely control automatic switching among a plurality of wireless communication channels 378-1, 378-2, to 378-n for the wireless peripheral device 356.

By way of example, the dongle 390 may be operatively coupled to a USB port of a docking station associated with the information handling system 300. As the information handling system 300 is operatively coupled to the docking station, the wireless peripheral device 356, via the dongle 390, it may communicate with the information handling system 300 using the first communication protocol that may be the proprietary RF protocol discussed in embodiments herein due to the dongle 390 acting as an intermediary communication device. The information handling system 300 detects that the dongle 390 is coupled to a docking station or other device or information handling system 300 itself. In such a case, the dongle 390 and the proprietary RF protocol have a priority over other wireless protocols as it is assumed that use of the dongle 390 indicates a user preference for the RF protocol. Moreover, the proprietary RF protocol may have additional RF features and capabilities, such as gaming focused enhancements or other enhancements, which may make use of the RF dongle 390 more stable and desirable in some embodiments.

However, in instances where the user, even temporarily, leaves the docking station and dongle 390 by physically carrying away the wireless peripheral device 356 and information handling system 300, information handling system 300 also detects the dongle 390 is no longer available to act as this intermediary communication device. In this instance, the wireless peripheral device hardware microcontroller may also receive GATT over-the-air messaging that the dongle 390 is no longer available to use as this intermediary communication device and may establish a wireless link according to a next best alternative wireless communication protocol that has been silently paired or a last-used wireless communication protocol and channel, such as BT or BLE wireless connection on 378-2 with the information handling system 300. This allows the user to still operate the wireless peripheral device 356 with the information handling system 300 even where the dongle 390 is no longer available. This further allows the user to not have the dongle 390 occupy a USB port at the information handling system 300 and still have the wireless peripheral device 356 operate as an input device when the dongle 390 at the docking station is not available in some example embodiments. As a consequence, the USB port at the information handling system 300 that would have otherwise been occupied by the dongle 390 is now free to be used by another peripheral device while the dongle 390 remains at the USB port of the docking station.

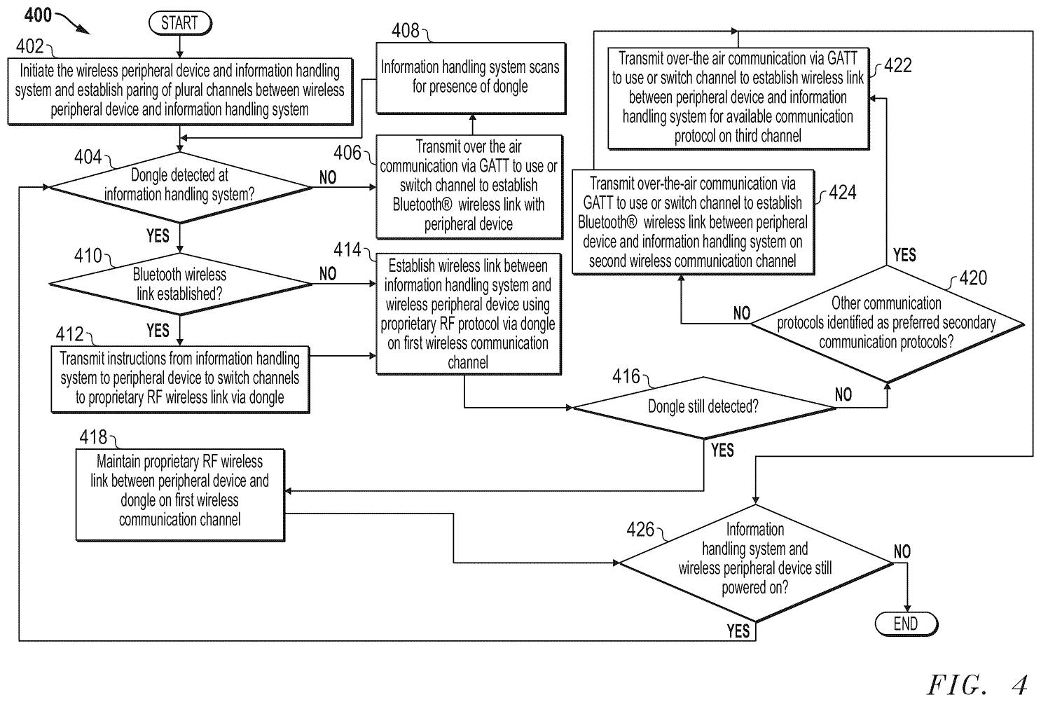

FIG. 4 is a flowchart showing a method 400 of automatically switching wireless communication between a wireless peripheral device and an information handling system to prioritize wireless links established via a dongle, when available according to an embodiment of the present disclosure. As described herein, the user or an internet technology decision maker (ITDM) for an enterprise may set an automatic wireless connection switching module of an information handling system and an automatic wireless connection switching agent of a wireless peripheral device to prioritize a preferred wireless link established via a dongle operatively coupled to the information handling system over any other wireless communication protocols, such as Bluetooth®, BLE, or other WLAN connections. A first wireless communication channel may thus be selected by the automatic wireless connection switching module to cause the wireless peripheral device to communicate with the information handling system via the dongle using preferred wireless link at a specific radio frequency. The automatic wireless connection switching module and corresponding agent at the wireless peripheral device in an embodiment may work in tandem to scan for, detect when present, and automatically switch over to the preferred wireless link via the dongle when presence of the dongle is detected.

At block 402, the wireless peripheral device and information handling system may be initiated and pairing of plural channels may be established between the wireless peripheral device and the information handling system. In some embodiments, this may occur simultaneously. In other embodiments, the wireless peripheral device or information handling system may be powered up prior to powering up of the other device. In an embodiment, the dongle and the wireless peripheral device may be preprogrammed with pairing authentication data that is used to automatically and silently, wirelessly pair and bond the dongle with the wireless peripheral device. The wireless peripheral device in an embodiment is operatively coupled to the information handling system, at least initially, via a dongle. In an embodiment, the wireless peripheral device may transceive data to and from the information handling system via a first wireless communication channel. As such, as the wireless peripheral device is initiated and the dongle has been inserted into, for example, a USB port of the information handling system, the wireless peripheral device may communicate with the information handling system.

As described herein, as the wireless peripheral device is operatively coupled to the information handling system via the dongle, the wireless peripheral device may request, automatically, Bluetooth® (BT) pairing pre-authorization data or pairing credentials for pairing via another wireless communication protocol from the information handling system on top of or in addition to the proprietary RF protocol pairing via the dongle. After the BT pairing pre-authorization data or other pairing credentials have been exchanged via the dongle to and from the wireless peripheral device and information handling system, each of the wireless peripheral device and the information handling system may execute a minimal touch pairing mechanism such as a Dell Pair system, using the pre-loaded BT pairing credentials, seed values or the like, as given within the BT pairing pre-authorization data or generated using such BT pairing pre-authorization data to pair the wireless peripheral device and the information handling system via BT or BLE wireless communication protocol or other wireless communication protocol. This may occur silently in the background while the information handling system continues to communicate wirelessly with the wireless peripheral device via the proprietary RF protocol wireless link dedicated to the first wireless communication channel.

In an embodiment, the wireless peripheral device may dedicate at least one of a first wireless communication channel, a second wireless communication channel, or any nth wireless communication channel to communication using wireless links established according to each of the proprietary RF wireless communication protocol, and the BT or BLE communication protocol, or other wireless communication protocol, such as Wi-Fi using the silent pairing techniques described directly above. The dedication of the BT pairing data to a specific wireless communication channel, such as a second wireless communication channel allows the wireless peripheral device to alternatively communicate with the information handling system without the use of the dongle while using the second wireless communication channel. This allows the wireless peripheral device to automatically switch from a communication with the information handling system using the first (e.g., proprietary RF) communication protocol via the dongle to communicating with the information handling system using another wireless protocol such as a BT or BLE communication protocol, or other wireless protocol, such as Wi-Fi.

As described herein, the wireless peripheral device may execute computer-readable program code instructions, via over-the-air messaging such as BLE GATT messaging to establish a wireless link between the wireless peripheral device 356 and the information handling system 300 via a plurality of communication channels available at the wireless peripheral device. Such over-the-air messaging may be executed using a secure extended direct GATT communication transmitted directly to a secure BLE wireless peripheral device address that is specific to the wireless peripheral device 356. This effectively allows the information handling system 300 to remotely control automatic switching among a plurality of wireless communication channels 378-1, 378-2, to 378-n for the wireless peripheral device 356.

The hardware processor of the information handling system executing code instructions of the automatic wireless connection switching module (e.g., 163 of FIG. 1) may determine in an embodiment at block 404 whether a wireless communication dongle has been operatively coupled to the information handling system. As described herein, a dongle may be operatively coupled to the information handling system, for example, via a Universal Serial Bus (USB) port at the information handling system. Such a dongle, in an embodiment, may be capable of wireless communication via a proprietary radio frequency (RF) wireless communication protocol. In an embodiment, this first wireless communication protocol may be proprietary to the manufacturer of the dongle and wireless peripheral device and provide for proprietary modulation, wireless data transfer, pairing techniques and other characteristics for the proprietary RF protocol. Moreover, the proprietary RF protocol may have additional RF features and capabilities, such as gaming focused enhancements or other enhancements, which may make use of the RF dongle more stable and desirable in some embodiments.

The hardware processor for the information handling system executing code instructions of the automatic wireless communication switching module (e.g., 163 of FIG. 1) may detect that such a dongle has been operatively coupled to the information handling system when the power management unit at the information handling system supplies power to the dongle via such a USB port connection, for example. The hardware processor for the information handling system may also execute code instructions of the automatic wireless connection switching module to detect the dongle at the docking station, external display, or other external device in an example embodiment. If the dongle is not detected at the information handling system, this may indicate that wireless communication with the wireless peripheral device via the dongle is not currently available, and the method may proceed to block 406 for immediate establishment of a wireless link directly with a radio of the wireless peripheral device and a wireless radio of the information handling system using a wireless communication protocol other than the proprietary radio frequency (RF) wireless protocol supported by the dongle, such as BT or BLE. An over-the-air (OTA) instructions to switch to an alternative channel may be sent to the wireless peripheral device from the information handling system, if the dongle is detected at the information handling system, docking station, or at block 404 Establishing a wireless link with the wireless peripheral device via the dongle may be possible, and the method may proceed to block 410 for instructing the wireless peripheral device to attempt to establish such a wireless link.

At block 406, in an embodiment in which the dongle is not detected at the information handling system, the hardware processor of the information handling system executing code instructions of the automatic wireless connection switching module may direct the wireless radio of the information handling system to send a BLE GATT communication or other OTA message to switch to the second wireless communication channel to establish a wireless link directly with a radio of the wireless peripheral device using an already-paired, available, parallel wireless communication protocol on that second wireless communication channel. For example, the wireless radio of the information handling system may send a BLE GATT communication or other OTA message to switch to the second wireless communication channel and to establish a wireless link with the wireless peripheral device according to the BT, BLE, or one of various Wi-Fi WLAN wireless connections in any number of frequency ranges, such as 2.4 GHz, 5 GHz, or 6 GHz. In some embodiments, the hardware processor executing code instructions of the automatic wireless connection switching module may automatically switch to a default BT or BLE wireless protocol such as a last-used wireless communication channel with a silently paired protocol when the dongle is not detected. In other embodiments, the hardware processor executing code instructions of the automatic wireless connection switching module may establish the wireless link at block 406 according to a predefined next best alternative wireless communication protocol, as described herein, based on RSSI, HDAM, or other determinations.

The hardware processor of the information handling system in an embodiment at block 408 may continue to detect the presence of the dongle. As described herein, execution of code instructions of the automatic wireless connection switching module at the information handling system may scan for and detect a dongle and transmit an OTA communication or instruction to a corresponding agent at the wireless peripheral device in an embodiment. The automatic wireless connection switching agent at the wireless peripheral device may work in tandem to automatically switch over to the first wireless communication channel for the proprietary RF protocol to communicate using a wireless link via the dongle when presence of the dongle is detected. While scanning for or waiting for detection of the dongle, the information handling system and the wireless peripheral device may continue to communicate wirelessly via the pre-paired BLE or BT wireless link established using the second wireless communication channel dedicated to the BLE wireless communication protocol at 406. The method may then return to block 404 for determination as to whether the dongle has been detected.

At block 410, in an embodiment in which the information handling system has detected the presence of the dongle at block 404, the hardware processor of the information handling system executing code instructions of the automatic wireless connection switching module may determine whether the information handling system is currently in wireless communication with the wireless peripheral device according to a wireless communication protocol (e.g., Bluetooth® (BT), Bluetooth® Low Energy (BLE), wide area local network (WLAN) Wi-Fi) other than the proprietary RF protocol supported by the dongle. If the information handling system is already in wireless communication with the wireless peripheral device via such another wireless communication protocol, the method may proceed to block 412 for the information handling system to transmit instructions, via the already established wireless link, using a secure extended directed generic attribute profile (GATT) communication at a BLE host address specific to the wireless peripheral device, to the automatic wireless connecting switching agent at the wireless peripheral device to attempt to switch communications over to a wireless link established via the dongle. If the information handling system is not already in wireless communication with the wireless peripheral device via such another wireless communication protocol, the method may proceed to block 414 for the automatic wireless connecting switching agent at the wireless peripheral device to attempt to switch communications over to a first wireless communication channel dedicated to wireless links established via the dongle using a proprietary RF protocol.

In an embodiment in which the information handling system is already in wireless communication with the wireless peripheral device at block 412, the wireless radio of the information handling system may transmit, via the already established wireless link with the wireless peripheral device, instructions to the automatic wireless connecting switching agent at the wireless peripheral device to attempt to switch communications over to a wireless link established via the dongle. Such instructions in an embodiment may be generated by the automatic wireless connecting switching module at the information handling system. These instructions may include instructions to attempt to establish a wireless link to the dongle. In some embodiments, such instructions may be provided via the existing BT or BLE wireless link with a BLE GATT message that is transmitted to the wireless peripheral device. In other embodiments, such instructions may include instructions to ping or request to connect to the dongle. These instructions may further include directions to automatically switch from the currently established wireless link (e.g., BT, BLE, WLAN wireless link) to a preferred wireless link established via the dongle according to the proprietary RF wireless communication protocol, upon establishing communication with the dongle. In another aspect of an embodiment, these instructions may direct the automatic wireless connecting switching agent operating at the wireless peripheral device to establish a wireless link via an available next best alternative wireless communication protocol defined by a user or an internet technology decision maker (ITDM) when communication with the dongle cannot be established. The wireless peripheral device may then proceed to establish a preferred proprietary RF protocol wireless link with the dongle on the first wireless communication channel for operative coupling and use of the wireless peripheral device.

At block 414, in an embodiment in which the information handling system is not currently in wireless communication with the wireless peripheral device, via another protocol, the wireless radio of the information handling system may transmit, via secure extended directed generic attribute profile (GATT) communication, or GATT messaging at a BLE host address specific to the wireless peripheral device, instructions to the automatic wireless connecting switching agent at the wireless peripheral device to switch communications over to a proprietary RF protocol wireless link established on a silently paired first wireless communication channel via the dongle. Such instructions in an embodiment may be identical to those transmitted at block 412 above, although they may be transmitted via a different type of communication. The wireless peripheral device may then proceed to establish a preferred proprietary RF protocol wireless link on the first wireless communication channel with the dongle.

In an embodiment at block 416 in which the information handling system has transmitted to the wireless peripheral device instructions to switch to the first wireless communication channel using the proprietary RF protocol wireless link with the dongle, a microcontroller at the wireless peripheral device may execute code instructions of the automatic wireless connection switching module at the information handling system to monitor for the operative coupling to the dongle. If the information handling system continues to detect presence of the dongle, the wireless peripheral device may maintain communication through the proprietary RF protocol on the first wireless communication channel via the dongle at block 418.

At block 420, in an embodiment in which the information handling system does not detect the dongle at the information handling system, docking station, external display, or other intermediate device, the information handling system may execute code instructions of the automatic wireless connecting switching module to determine a different, parallel, silently paired alternative wireless communication protocol. As described herein, the user or an ITDM may set the automatic wireless connection switching module to identify a next best alternative wireless communication protocol (e.g., BT, BLE, WLAN in a specific RF band such as 2.5 GHz, 5 GHz, or 6 GHz) to be used to establish a wireless link between the information handling system and the wireless peripheral device when the preferred proprietary RF protocol wireless link to the dongle using the first wireless communication channel is unavailable. If a next best alternative wireless communication protocol has not been predefined, the method may proceed to block 424 for switching to a silently paired, parallel wireless link on a second, third, or nth wireless communication channel according to a default wireless communication protocol, or a last used wireless communication channel that supports a wireless protocol other than the proprietary RF protocol, such as BT or BLE. If a next best alternative wireless communication protocol has been predefined, the method may proceed to block 422 for switching to a silently paired, parallel wireless link established at a third wireless communication channel according to the next best alternative wireless communication protocol.

In an embodiment in which a next best alternative wireless communication protocol has not been predefined, the hardware processor for the information handling system executing code instructions of the automatic wireless connecting switching module at block 424 may transmit a GATT communication or other OTA communication instruction to direct the wireless peripheral device to switch to a silently paired, parallel wireless link according to a default wireless communication protocol on another wireless communication channel, such as a third wireless communication channel, that is silently paired, or a last used wireless communication channel that supports a wireless protocol other than the proprietary RF protocol, such as BT or BLE. Alternatively, at block 422, in an embodiment in which a next best alternative wireless communication protocol has been predefined, the hardware processor for the information handling system executing code instructions of the automatic wireless connecting switching module may transmit a GATT communication or other OTA communication instruction to direct the wireless peripheral device to switch to a silently paired, parallel wireless link on the third wireless communication channel dedicated to wireless communication using the predefined next best alternative wireless communication protocol, such as Wi-Fi, for example

At block 426, in an embodiment, it may be determined whether the information handling system and wireless peripheral device remain powered on. If the information handling system and wireless peripheral device remain powered on, the method may proceed back to block 404 for routine monitoring to detect whether the dongle is or is not present and operatively coupled to the information handling system via a USB port, docking station, external display device, or other intermediary device. If the information handling system or wireless peripheral device is powered down in an embodiment, the method for automatically switching wireless communication between a wireless peripheral device and an information handling system to prioritize wireless links established via a dongle, when available, may then end. In such a way, the automatic wireless connection switching module and corresponding agent at the wireless peripheral device in an embodiment may work in tandem to scan for, detect when present, and automatically switch over to the preferred wireless link with the dongle when the dongle presence is detected.

The blocks of the flow diagrams of FIG. 4 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. A wireless peripheral device comprising:
a hardware microcontroller;
a data storage device;
a wireless radio to operatively couple the wireless peripheral device to an information handling system via a plurality of wireless communication channels, each silently-paired and supporting one of a plurality of wireless communication protocols that have been previously used to pair the information handling system to the wireless peripheral device using a silent pairing process;
a power management unit to provide power to the hardware microcontroller, the data storage device, and the wireless radio;
the wireless radio transceiving wireless data to the information handling system via a first wireless link on a first of the plurality of wireless communication channels using a first wireless protocol;
the wireless radio to receive a first over-the-air (OTA) message from the information handling system indicating presence of a dongle allowing for wireless dongle transceptions between the wireless peripheral device and the information handling system; and
the hardware microcontroller to execute computer-readable program code instructions of an automatic wireless connection switching agent to automatically switch to establish a second wireless link with the information handling system via the dongle on a second of the plurality of wireless communication channels dedicated to transceiving data according to a second wireless communication protocols that is also supported by the dongle.

2. The wireless peripheral device of claim 1, wherein the OTA message is a Bluetooth® Low Energy (BLE) generic attribute profile (GATT) message.

3. The wireless peripheral device of claim 1, wherein the first wireless communication protocols is a BLE wireless protocol and the second wireless protocol is a propriety radio frequency (RF) communication protocol.

4. The wireless peripheral device of claim 1 further comprising:
the wireless radio to receive a second OTA message from the information handling system indicating absence of a dongle; and
the hardware microcontroller to execute computer-readable program code instructions of the automatic wireless connection switching agent to switch to the first of the plurality of wireless communication channels that is silently paired and automatically establish the first wireless link with the information handling system for transceiving data according the first wireless communication protocol.

5. The wireless peripheral device of claim 1 further comprising:
the wireless radio to receive a second OTA message from the information handling system indicating absence of a dongle; and
the hardware microcontroller to execute computer-readable program code instructions of the automatic wireless connection switching agent to determine that the first of the plurality of wireless communication channels is unavailable and to automatically switch to a third of the plurality of wireless communication channels that is silently paired and automatically establish a third wireless link with the information handling system for transceiving data according a third wireless communication protocol.

6. The wireless peripheral device of claim 5, wherein the third of the plurality of wireless communication channels that is silently paired and automatically establishing the third wireless link with the information handling system for transceiving data according the third wireless communication protocol that is a wide area local network (WLAN) communication protocols in the 2.4 GHz frequency range.

7. The wireless peripheral device of claim 1 further comprising:
the wireless radio to receive a second OTA message from the information handling system indicating absence of a dongle; and
the hardware microcontroller to execute computer-readable program code instructions of the automatic wireless connection switching agent to automatically switch to another of the plurality of wireless communication channels that is silently paired according to a pre-defined set of next best alternative wireless communication protocols to the second of the plurality of wireless communication protocols with the dongle by a user or an internet technology decision maker (ITDM).

8. A method of automatically switching wireless links between a wireless peripheral device and an information handling system to prioritize use of a dongle comprising:
operatively coupling, via a wireless radio of the wireless peripheral device, the wireless peripheral device to an information handling system via a plurality of silently paired wireless communication channels, each of the silently paired plurality of wireless communication channels to support one of a plurality of wireless communication protocols that have been previously used to pair the information handling system to the wireless peripheral device using a silent pairing process;
receiving, via the wireless radio, a first over-the-air (OTA) message from the information handling system indicating presence of a dongle allowing for wireless dongle transceptions between the wireless peripheral device and the information handling system according to a proprietary radio frequency (RF) wireless communication protocol; and
automatically switching, via a hardware microcontroller executing computer-readable program code instructions of an automatic wireless connection switching agent, to a first of the silently paired plurality of wireless communication channels supporting a first wireless link with the information handling system via the dongle from a second of the silently paired plurality of wireless communication channels dedicated to transceiving data according to a Bluetooth® Low Energy (BLE) wireless communication protocol that is supported by the second of the silently paired plurality of wireless communication channels.

9. The method of claim 8 further comprising:
receiving, via the wireless radio, a second OTA message from the information handling system indicating absence of a dongle; and
automatically switching to the second of the silently paired plurality of wireless communication channels establishing a second wireless link, via the wireless radio, with the information handling system transceiving data according to the BLE wireless communication protocol.

10. The method of claim 8 further comprising:
receiving, via the wireless radio, a second OTA message from the information handling system indicating absence of a dongle; and
automatically switching to a third of the silently paired plurality of wireless communication channels establishing a third wireless link, via the wireless radio, with the information handling system transceiving data according to wide area local network (WLAN) communication protocols transceiving in a third wireless communication protocol when a second wireless communication protocol that is the BLE wireless communication protocol is unavailable at the second of the silently paired plurality of wireless communication channels.

11. The method of claim 8, wherein the OTA message is a Bluetooth® Low Energy (BLE) generic attribute profile (GATT) message.

12. The method of claim 8 further comprising:
receiving, via the wireless radio, a second OTA message from the information handling system indicating absence of a dongle; and
automatically switching to a third of the silently paired plurality of wireless communication channels establishing a third wireless link, via the wireless radio, with the information handling system transceiving data according to a Bluetooth® communication protocol, via the hardware microcontroller executing computer-readable program code instructions of the automatic wireless connection switching agent.

13. The method of claim 8 further comprising:
determining the dongle is not detected;
determining unavailability of the first of the silently paired plurality of wireless communication protocols that has been pre-defined as a next best alternative wireless communication protocol to the second of the silently paired plurality of wireless communication protocols to the by a user or an internet technology decision maker (ITDM); and
automatically switching to a third of the silently paired plurality of wireless communication channels establishing a third wireless link, via the wireless radio, with the information handling system transceiving data according to a Bluetooth® communication protocols, via the hardware microcontroller executing computer-readable program code instructions of the automatic wireless connection switching agent.

14. An information handling system operably couplable to a wireless peripheral device comprising:
a hardware processor;
a data storage device;
a wireless radio to operatively couple the information handling system to the wireless peripheral device, via a plurality of wireless communication protocols that have been previously used to pair the information handling system to the wireless peripheral device using a silent pairing process;
a power management unit to provide power to the hardware processor, the data storage device, and the wireless radio;
the hardware processor to detect the presence of a dongle allowing for wireless dongle transceptions between the wireless peripheral device and the information handling system; and
the hardware processor executing computer-readable program code instructions of an automatic wireless connection switching module to establish via a first wireless link with the dongle using a first of the plurality of wireless communication protocols for wireless communication that is a proprietary radio frequency (RF) wireless communication protocol on a first of the plurality of wireless communication channels where the dongle is detected; and
the hardware processor to detect the absence of the dongle and executing computer-readable program code instructions of the automatic wireless connection switching module to transmit an over-the-air (OTA) message to the wireless peripheral device to switch to a second of the plurality of wireless communication channels having a silently-paired second wireless communication protocol for wireless communication via a second wireless link; and
the wireless radio establishing the second wireless link with the wireless peripheral device.

15. The information handling system of claim 14 further comprising:
the hardware processor to detect the presence of a dongle operatively coupled to an intermediary docking station and allowing for the wireless dongle transceptions between the wireless peripheral device and the information handling system.

16. The information handling system of claim 14 further comprising:
the wireless radio transceiving data on the second wireless link according to a Bluetooth® wireless communication protocol as the second wireless communication protocol. the hardware processor to detect the presence of a dongle allowing for wireless dongle transceptions between the wireless peripheral device and the information handling system.

17. The information handling system of claim 14, wherein the OTA message is a Bluetooth® Low Energy (BLE) generic attribute profile (GATT) message.

18. The information handling system of claim 14 further comprising:
the wireless radio transceiving data on a secondary wireless link according to a Bluetooth® Low Energy (BLE) wireless communication protocol.

19. The information handling system of claim 14 further comprising:
the wireless radio transceiving data on the second wireless link according to the second wireless communication protocol pre-defined as a next best alternative wireless communication protocol to the first wireless link by a user or an internet technology decision maker (ITDM).

20. The information handling system of claim 14 further comprising:
the wireless radio transceiving data on the second wireless link according to a wireless local area network (WLAN) wireless communication protocol in the 2.5 GHz frequency range.
